(19) United States
(12) Patent Application Publication
(10) Pub. No.: US 2025/0203552 A1
(43) Pub. Date: Jun. 19, 2025

(54) COVERAGE OPPORTUNITY ENHANCEMENT FOR WIRELESS DEVICES

(71) Applicant: T-Mobile Innovations LLC, Overland Park, KS (US)

(72) Inventors: Ramesh JOSYULA, Redmond, WA (US); Kiranpal CHAGGAR, Bellevue, WA (US); Satish PACHALLA, Sammamish, WA (US); Ting ZHANG, Bellevue, WA (US); Baquer Ali CHABUK SAVAR, Auburn, WA (US)

(21) Appl. No.: 18/539,504

(22) Filed: Dec. 14, 2023

(51) Int. Cl. H04W 60/04; H04L 61/50; H04L 67/55; H04L 101/654

(52) U.S. Cl. CPC H04W 60/04; H04L 61/50; H04L 67/55; H04L 2101/654

(57) ABSTRACT

A method for coverage opportunity enhancement includes identifying a wireless device within a selected network coverage area for a cellular network based on information contained in a registration request from the wireless device. The method additionally includes accessing a database to correlate the information contained in the registration request with a mobile station international subscriber director number (MSISDN). The method additionally includes sending a push notification to the MSISDN of the wireless device, the push notification indicating coverage availability of the cellular network in the selected network coverage area.

### TECHNICAL BACKGROUND

A wireless network, such as a cellular network, can include an access node (e.g., base station) serving multiple wireless devices or user equipment (UE) in a geographical area covered by a radio frequency (RF) transmission provided by the access node. Multiple cellular networks have evolved that compete for customers and have overlapping coverage areas. Customers typically select a cellular carrier based on a variety of factors, such as pricing, services, and coverage areas.

When a home network for a wireless device is not available, the wireless device continuously scans for available networks and sends registration requests to the available networks. Until a registration request is accepted or denied, the wireless devices do not know which networks are allowed networks and which networks are not allowed networks for the wireless device. With these registration requests, the wireless devices send information identifying the wireless device, for example, an international mobile subscriber identity (IMSI), a subscription permanent identifier (SUPI), or a subscription concealed Identifier (SUCI). In response, the cellular network receiving the request will determine whether the wireless device has access to the network based on the identifying information and respond accordingly.

When a wireless device does not have access to the network requested, the wireless device remains without coverage. Accordingly, a solution is needed for ensuring that wireless devices are able to obtain coverage in such situations.

### OVERVIEW

Exemplary embodiments described herein include systems, methods, processing nodes, and non-transitory computer readable mediums for identifying and leveraging coverage opportunities for wireless devices. An exemplary method includes identifying a wireless device within a selected network coverage area for a cellular network based on information contained in a registration request from the wireless device. The method additionally includes accessing a database to correlate the information contained in the registration request with a mobile station international subscriber director number (MSISDN). Further, the method includes sending a push notification to the MSISDN of the wireless device, the push notification indicating coverage availability of the cellular network in the selected network coverage area.

In an additional exemplary embodiment, a system is provided including communication circuitry receiving registration requests from wireless devices within a selected network coverage area of a cellular network. The system additionally includes a memory storing instructions and data. A processor accesses the stored instructions and performs multiple operations. The operations include identifying wireless device information within the registration requests and correlating the wireless device information with a corresponding MSISDN. The operations additionally include sending a push notification to the MSISDN of the wireless device, the push notification indicating coverage availability of the cellular network in the selected network coverage area.

In yet a further exemplary embodiment, a non-transitory computer-readable medium stores instructions executed by a processor to perform multiple operations. The operations include identifying a wireless device within a selected network coverage area for a cellular network based on an international mobile subscriber identity (IMSI) of the wireless device received with a registration request and accessing a database to correlate the IMSI with a MSISDN. The operations additionally include triggering a push notification to the MSISDN of the wireless device, the push notification indicating coverage availability of the cellular network in the selected network coverage area.

Further, in embodiments provided herein, the particular registration requests used for determining a selected area come from non-subscribing wireless devices. More specifically, the registration requests under consideration come from wireless devices subscribing to other cellular networks.

Additional exemplary embodiments include processing nodes performing the exemplary methods. The processing node stores instructions executed by a processor to perform the multiple operations.

### BRIEF DESCRIPTION OF THE DRAWINGS

FIG. 1 depicts an exemplary operating environment in accordance with the disclosed embodiments.

FIG. 2 depicts a further exemplary operating environment in accordance with disclosed embodiments.

FIG. 3 depicts a coverage opportunity enhancement system in accordance with disclosed embodiments.

FIG. 4 depicts an exemplary method for defining a selected coverage area in accordance with disclosed embodiments.

FIG. 5 is a flow chart illustrating a further method for coverage enhancement in accordance with a disclosed embodiment.

FIG. 6 is a flow chart illustrating additional details of a method for coverage opportunity enhancement in accordance with a disclosed embodiment.

### DETAILED DESCRIPTION

Exemplary embodiments described herein include systems, methods, processing nodes and computer readable mediums for coverage opportunity enhancement for wireless devices. Coverage opportunities may be identified by a cellular network based on registration requests received from wireless devices that are not eligible to connect to the cellular network. Eligibility may be determined, for example, based on a subscriber agreement between the wireless device subscriber and another cellular network or based on a roaming agreement between the cellular network and another cellular network. These agreements may be identified based on information provided from the wireless device to the cellular network during the registration request.

In embodiments provided herein, a system is provided in or is in communication with a core network of the cellular network. The system functions to identify a selected area of coverage opportunity. The identification is performed based on wireless device registration requests. Wireless devices continuously scan for coverage. Wireless devices subscribing to a wireless network scan for that particular network first. However, if that network is not available, the wireless devices scan for any other available networks. Other available networks may include networks having a roaming agreement with the network associated with the subscriber. However, the wireless devices are unaware of which networks are available and which are not. Accordingly, the wireless devices attempt to connect to all networks regardless of whether they are available to the wireless device. Embodiments provided herein collect data from wireless devices attempting to connect to the cellular network and based on this data, select an area in which network coverage is needed and other cellular networks are unable to provide the desired coverage.

Within the selected area, embodiments provided herein may receive registration requests from wireless devices that are not able to connect to the cellular network. However, instead of simply rejecting the registration requests, the system provided collects identifying information from the wireless devices and correlates the identifying information with a MSISDN of the wireless device. The correlation can be performed, for example, by consulting a database. Accordingly, once systems provided herein have the MSISDN of the wireless device, a push notification can be triggered to the MSISDN of the wireless devices. The push notification can inform the wireless device users that their preferred networks are not available but that there is a cellular network available. In some embodiments, the push notification may include a hyperlink allowing the wireless device user to subscribe to the available network. For example, the wireless user may have a pre-existing subscription to AT&T® or Verizon® networks. When neither of these networks is available, but the T-Mobile® network is available, the push notification may allow the wireless device users to subscribe to the T-Mobile® network in order to guarantee coverage in the selected area.

In embodiments provided herein, push notifications may be triggered based on a single registration request in the selected area. Push notifications would be sent to all non-subscribing users attempting to connect in the selected area. Alternatively, push notifications may be triggered based on multiple registration requests sent by a single wireless device in the selected area. In this instance, the push notifications would be sent to non-subscribing users who repeatedly try to connect in the selected area. Data may be collected that enables formation of heat maps showing the areas where other networks appear to lack coverage and wireless device users repeatedly attempt to connect to the cellular network. Accordingly, embodiments provided herein match wireless device users with a cellular network that offers coverage in their desired areas. This process benefits both the cellular network and the wireless device user.

In embodiments disclosed herein, a cell or wireless network may be provided by an access node. The access node may utilize one or more antennas to communicate with wireless devices or user equipment (UEs), such as for example, wireless phones, Internet of Things (IoT) devices, and wireless gateway devices. An exemplary system described herein includes a coverage opportunity enhancement system interacting with a core network and with at least an access node (or base station), such as an eNodeB, or gNodeB, as well as one or more end-user wireless devices. For illustrative purposes and simplicity, the disclosed technology including a coverage opportunity enhancement system will be illustrated and discussed as being implemented responsive to the communications between an access node (e.g., a base station) and a wireless device It is understood that the disclosed technology may also be applied to communication between an end-user wireless device and various network resources, such as relay nodes, controller nodes, antennas, etc. Further, multiple access nodes may be utilized. For example, some wireless devices may communicate with an long term evolution (LTE) eNodeB and others may communicate with a new radio (NR) gNodeB.

In addition to the systems and methods described herein, the operations for coverage opportunity identification and enhancement may be implemented as computer-readable instructions implemented by an access node or other network nodes such as processing nodes.

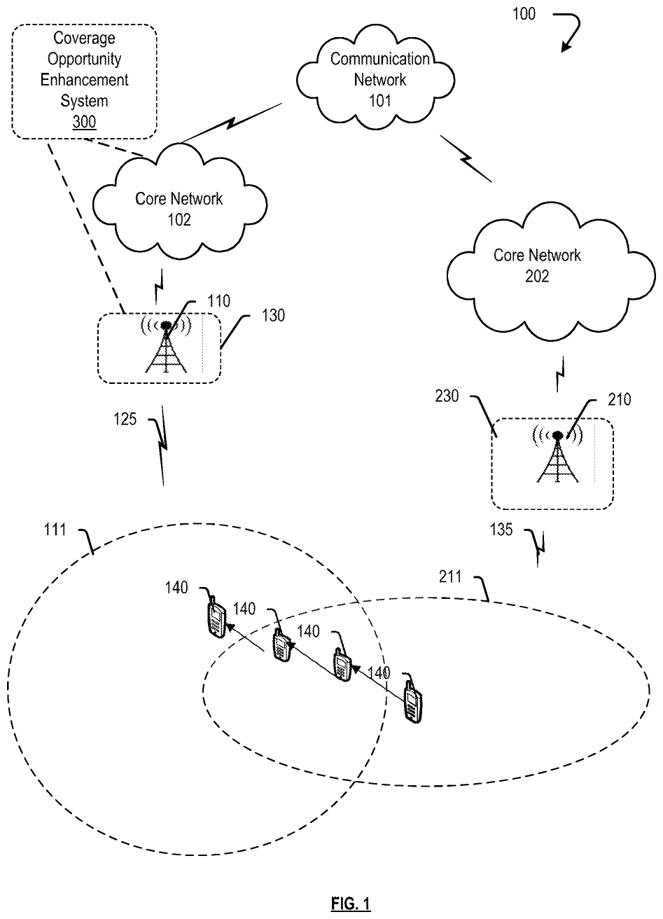

FIG. 1 depicts an exemplary environment 100 for embodiments disclosed herein. A core network 102 is coupled to a radio access network (RAN) 130 including access node 110. Further, a core network 202 may be associated with another cellular network and may communicate with a RAN 230 having access nodes or base stations 210. The core networks 102, 202 and RANs 130, 230 serve wireless devices 140 over communication links 125 and 135. The core networks 102 and 202 along with associated RANs 130, 230 may belong to distinct cellular networks.

The wireless devices 140 can include end-user wireless devices (e.g., UEs). The communication links 125 and 135 may use 5G NR, 4G LTE, 6G, or any other suitable type of radio access technology (RAT). Core networks 102, 202 can be structured as an evolved packet core (EPC) network or as a 5G core using a service-based architecture (SBA) utilizing core network functions and elements, including, for example, user plane functions (UPF) control plane functions (CPF). The core network 102 provides access to a communication network 101, such as the Internet or other packet data network.

The RANs 130, 230 can include various access network functions and devices disposed between the core networks 102, 202 and the wireless devices 140. For example, the RAN 130 includes access nodes or base stations 110 and the RAN 230 includes access nodes or base stations 210. The access nodes or base stations 110, 210 may be or include eNodeBs and/or gNodeBs communicating with the plurality of wireless devices 140. The access nodes 110, 210 may operate within coverage areas 111 and 211 by deploying the links 125 and 135 respectively. The wireless links 125 and 135 may correspond to the same or different RATs, frequency bands, or bandwidths. Coverage areas 111 and 211 are shown as having a defined boundary and signal parameters may vary between the access nodes 110, 210 and the boundaries of the coverage areas 111 and 211. Specifically, signal parameters generally deteriorate as devices progress towards the boundary of the coverage areas 111 and 211.

It is understood that the disclosed technology may also be applied to communication between an end-user wireless device and other network resources, depending on the RAT and network technology being implemented. Further, either of core network 102, 202 and RAN 130, 230 can include one or more of a local area network, a wide area network, and an internetwork (including the Internet) capable of communicating signals and carrying data, for example, to support voice, push-to-talk, broadcast video, and data communications by wireless devices 140. Alternatively or additionally to the UPF and CPF, the illustrated network topology can include packet gateways, such as a CUPS based user plane S-GW, P-GW, or SAE-GW.

The core networks 102, 202 may incorporate many functions not shown in FIG. 1. For example, the CPF may include but are not limited to a Network Slice Selection Function (NSSF), a Network Exposure Function (NEF), a NF Repository Function (NRF), a Policy Control Function (PCF), a Unified Data Management (UDM), an Application Function (AF), a Short Message Service Function (SMSF), a Core Access and Mobility management Function (AMF), a Session Management Function (SMF), and an Authentication Server Function (AUSF). The AMF may be utilized to handle registration requests from the wireless devices 140. The UPF may also include, for example, a Unified Data Repository (UDR). In an evolved packet core (EPC) environment, the core network 102 may include a mobility management entity (MME) for handling the registration requests from the wireless devices 140.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 140. Wireless network protocols can comprise Multimedia Broadcast Multicast Services (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), or 6G. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

The exemplary operating environment 100 may further include coverage opportunity enhancement system 300, which is illustrated as operating between the core network 102 and the RAN 130. However, it should be noted that the coverage opportunity enhancement system 300 may operate in the core 102, in the RAN 130 or may be distributed. For example, the coverage opportunity enhancement system 300 may utilize components located at both the core network 102 and at the multiple access nodes 110. Alternatively, the coverage opportunity enhancement system 300 may be an entirely discrete system operating in conjunction with the RAN 130, core 102 and/or the wireless devices 140.

The coverage opportunity enhancement system 300 receives information pertaining to wireless devices 140 attempting to connect to the network including the core network 102 and the RAN 130. For example, the coverage opportunity enhancement system 300 may collect data regarding the number of attempted connections from devices 140 that do not belong to the cellular network (non-subscribing wireless devices) as these attempted connections illustrate weakness of other cellular networks in particular areas. Furthermore, the coverage opportunity enhancement system 300 may collect identifying data from the wireless devices 140 sending registration requests and derive a MSISDN of the wireless device from the identifying data. Additionally, the coverage opportunity enhancement system 300 may trigger a push notification to the MSISDN of the wireless devices 140, thereby broadcasting availability of a cellular network in the particular area.

Wireless devices 140 may be any device, system, combination of devices, or other such communication platform capable of communicating wirelessly with RANs 130, 230 using one or more frequency bands deployed therefrom. Each of the wireless devices 140 may be, for example, a mobile phone, a wireless phone, a wireless modem, a personal digital assistant (PDA), a voice over internet protocol (VOIP) phone, a voice over packet (VOP) phone, or a soft phone, as well as other types of devices or systems that can exchange audio or data via RAN 120. Wireless devices 140 may also include, for example Internet of Things (IoT) devices or home internet (HINT) devices.

The environment 100 shown in FIG. 1 illustrates movement of the wireless device 140 over time. As illustrated, wireless device 140 may begin operating within the coverage area 211, but may move into the coverage area 111 and out of the coverage area 211 over time. The wireless device 140 may be a subscriber to the cellular network including core network 202 and access node 210. Once the wireless device is completely outside of the coverage area 211 and is centrally located within the coverage area 111, it may begin to send registration requests over the communication link 125 to the access node 110 and ultimately to the core network 102, which may belong to a different cellular network to which the wireless device 140 does not subscribe. The coverage opportunity enhancement system 300 may detect the registration request from the non-subscribing wireless device 140 that is not eligible to connect to the network. In response, the coverage opportunity enhancement system 300 may trigger a push notification to be transmitted, for example by the access node 110 to the wireless device 140. The push notification may provide the user with information regarding an available cellular network corresponding to the core network 102 and may allow the wireless device user to subscribe to the available cellular network via a hyperlink contained in the push notification.

Other network elements may be present to facilitate communication but are omitted for clarity, such as base stations, base station controllers, mobile switching centers, dispatch application processors, and location registers such as a home location register or visitor location register. Components not specifically shown in FIG. 1 can further include processing nodes, controller nodes, routers, gateways, and physical and/or wireless data links for communicating signals among various network elements, additional base stations, controller nodes, telephony switches, internet routers, network gateways, computer systems, communication links, or other type of communication equipment, and combinations thereof.

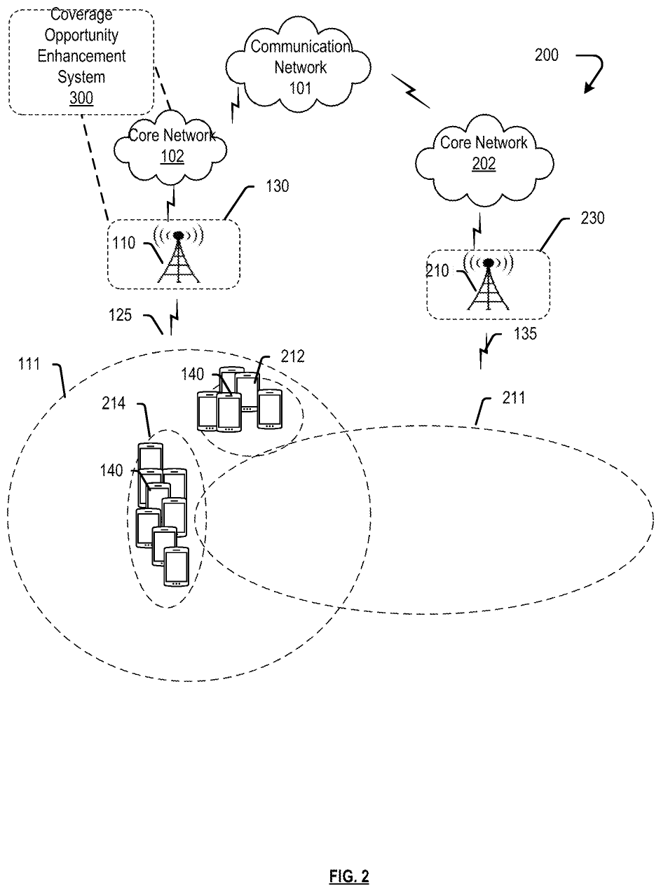

FIG. 2 illustrates a further environment 200 for operation of the coverage opportunity enhancement system 300. Like reference numerals from FIG. 1 refer to the same above-described components. Accordingly, the core networks 102, 202, and RANS 130, 230 may operate within two different cellular networks. FIG. 2 further illustrates wireless devices 140 collected in two areas 212 and 214. The areas 212 and 214 may represent areas identified by the coverage opportunity enhancement system 300 as selected areas. As further described herein, the selected areas 212 and 214 may be areas from which the access node 110 and core network 102 receive the largest number of registration requests from unaffiliated or non-subscribing wireless devices 140 that do not subscribe to the cellular network having the core network 102 and the RAN 130. The need for the wireless devices 140 to connect to the cellular network in the selected areas 212 and 214 illustrates the weakness of other cellular networks in these selected areas.

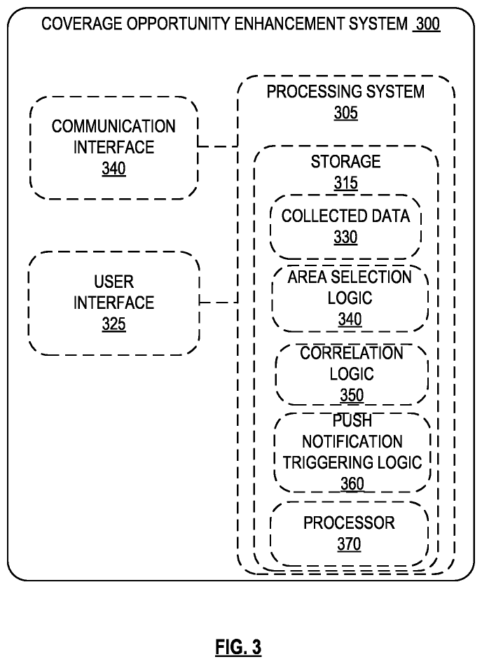

Components of the coverage opportunity enhancement system 300 are further described with reference to FIG. 3. The coverage opportunity enhancement system 300 may be configured for collecting data transmitted by the wireless devices 140 to the access nodes 110. To perform coverage opportunity identification, the coverage opportunity enhancement system 300 may utilize a processing system 305.

Processing system 305 may include a processor 310 and a storage device 315. Storage device 315 may include a RAM, ROM, disk drive, a flash drive, a memory, or other storage device configured to store data and/or computer readable instructions or codes (e.g., software). The computer executable instructions or codes may be accessed and executed by processor 305 to perform various methods disclosed herein. Software stored in storage device 315 may include computer programs, firmware, or other form of machine-readable instructions, including an operating system, utilities, drivers, network interfaces, applications, or other type of software. For example, software stored in storage device 315 may include a module for performing various operations described herein. For example, area selection logic 340 may store instructions to tabulate a number of and a location of registration requests from non-subscribing or unaffiliated wireless devices and select target areas based on the number of registration requests from the various locations. Correlation logic 350 may leverage collected data 330 to identify wireless devices 140 and to correlate the identifying information with a MSISDN or each wireless device. The correlation logic 350 may, for example, trigger searching of a database to identify the MSISDN from an IMSI or a SUCI or from other information forwarded by the wireless device 140 with the registration request. Additionally push notification triggering logic 360 may trigger a push notification to wireless device 140 allowing the wireless device 140 to subscribe to the cellular network or simply a push notification to inform the wireless device subscriber that strong coverage exists in the selected area for the cellular network. Further, the memory 315 may store collected data at 330, which may be or include data collected from the wireless devices 140.

To perform the above-described operations, the area selection logic 340, correlation logic 350, and push notification triggering logic 360 may be executed by the processor 370 to operate on the collected data 330. The access technology may include, for example, 4G LTE, 5GSA, 5G NSA, or 6G.

Processor 370 may be a microprocessor and may include hardware circuitry and/or embedded codes configured to retrieve and execute software stored in storage device 315. The coverage opportunity enhancement system 300 further includes a communication interface or communication circuitry 320 and a user interface 325. Communication interface 320 may be configured to enable the processing system 305 to communicate with other components, nodes, or devices in the wireless network. For example, the coverage opportunity enhancement system 300 receives relevant parameters from an access node 110 or from the wireless devices 140.

Communication interface 320 may include hardware components, such as network communication ports, devices, routers, wires, antenna, transceivers, etc. User interface 325 may be configured to allow a user to provide input to the coverage opportunity enhancement system 300 and receive data or information from access node 110 or the wireless devices 140. User interface 325 may include hardware components, such as touch screens, buttons, displays, speakers, etc. The coverage opportunity enhancement system 300 may further include other components such as a power management unit, a control interface unit, etc.

The location of the coverage opportunity enhancement system 300 may depend upon the network architecture. As set forth above, the coverage opportunity enhancement system 300 may be located in the core network 102, in a separate processing node, in the RAN 130, in multiple locations or may be an entirely discrete component. Further, although shown as a single integrated system, the functions of data collection, area selection, correlation, and push notification triggering described herein may be separated and disposed in separate locations.

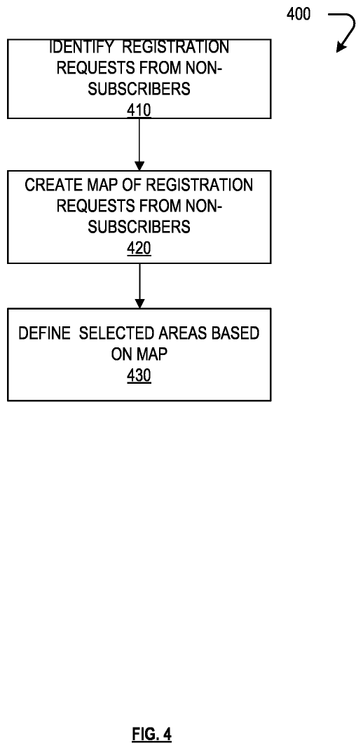

The disclosed methods for coverage opportunity enhancement are further described below with reference to FIGS. 4-6. FIG. 4 illustrates an exemplary method 400 performed by the coverage opportunity enhancement system 300. Method 400 may be performed by any suitable processor discussed herein, for example, the processor 370 included in the coverage opportunity enhancement system 300 or any other suitable processor. For the sake of convenience, the method is described as being performed by the processor 370.

Method 400 starts in step 410, when the processor 370 identifies registration requests from non-subscribing wireless devices. Non-subscribing wireless devices include wireless devices that subscribe to another cellular network. In some cases, the other cellular network may have a roaming agreement with the cellular network receiving the registration requests, in which case the registration request may be accepted. However, in other cases, the wireless devices 140 may be non-subscribers that do not subscribe to another cellular network having a roaming agreement with the cellular network receiving the registration requests. In this scenario, the registration requests are denied. In either case, the registration requests from non-subscribing wireless devices are tracked by the processor 370.

In step 420, the processor 370 creates a map of these registration requests from non-subscribing wireless devices. In some instances, the map may be a heatmap. Thus, a two dimensional visualization may be provided that represents the magnitude of requests from non-subscribers in different colors or with different shading. The variation in color may be a variation in hue or intensity, such that areas with a high number of requests are darker and areas with a lower number of requests are lighter. In embodiments set forth herein, the processor 370 may collect data from every non-subscribing wireless device in a cell or from every non-subscribing wireless device in multiple cells representing all of the cells in a cellular network or a portion of the cells in the cellular network.

Finally, in step 430, the processor 370 may define selected areas based on the created map. For example, the processor 370 may define and select areas having a darkest shading as being areas of particular weakness for other networks. These selected areas can then be utilized for communication with non-subscribing wireless devices to offer an opportunity for improved coverage. Accordingly, the processor 370 identifies the selected network coverage area from a heat map created based received registration requests.

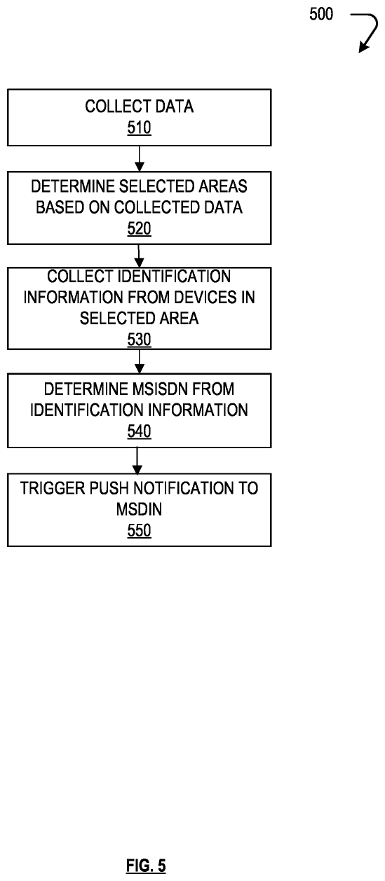

FIG. 5 illustrates a further method 500 for enhancing coverage for wireless devices in accordance with an embodiment. In particular, the method 500 illustrates a method for identifying the coverage opportunities and providing a push notification in order to enhance wireless device coverage for non-subscribing wireless devices. Method 500 may be performed by a processor, for example, the processor 370 in the coverage opportunity enhancement system 300. For the sake of illustration, the method is described as being performed by the processor 370.

Method 500 starts in step 510, when the coverage opportunity enhancement system 300 collects data from the non-subscribing wireless devices. In embodiments provided herein, the data is collected from non-subscribing wireless devices sending registration requests as described above with respect to FIG. 4.

In step 520, the processor 370 determines selected areas for coverage opportunity based on the data collected in step 510. As set forth with respect to FIG. 4, the selection or areas may be accomplished by preparing heat maps. However other methods that assess the density of registration requests from non-subscribing wireless devices may also be utilized. Further, steps 510 and 520 may occur continuously so as to refine selected areas over time based on the registration requests.

In step 530, the processor 370 may collect identification information from the non-subscribing wireless devices in the selected area sending registration requests. Identification information provided by wireless devices 140 during a registration request may depend upon a radio access technology (RAT) capability of the wireless device. As technology has evolved, different carriers within the cellular network may utilize different types of radio access technologies (RATs). RATs can include, for example, 3G RATs (e.g., GSM, CDMA etc.), 4G RATs (e.g., WiMax, LTE, etc.), 5G RATs (new radio (NR)), and 6G RATs. As access nodes have evolved, networks may include a combination of multiple access node such as 4G LTE evolved NodeBs (eNodeBs or eNBs) and 5G NR next generation NodeBs (gNodeBs or gNBs) or alternatively may be exclusively 4G or 5G cellular systems.

For example, the wireless device using a 4G RAT may provide the IMSI, which is a unique identifier assigned to a wireless device that is used to identify the wireless device and its associated subscription information. The IMSI is typically stored on the subscriber identify module (SIM) card of the wireless device and is used during initial registration and for authentication within a cellular network. The IMSI is usually presented as a 15-digit number with the first three digits representing the mobile country code (MCC), followed by the mobile network code (MNC) and finally the mobile subscription identification number (MSIN), which is usually 9-10 digits long.

Further alternatives include a temporary mobile subscriber identity (TMSI) that may be used instead of an IMSI to reduce signaling overhead and protect wireless device identity. A further potential identifier is the subscription permanent identifier (SUPI). The SUPI is a unique identifier used to represent a subscriber's permanent identity in a 5G network. As a further alternative, the subscription concealed identifier (SUCI) may be provided in 5G networks. The SUCI is a temporary identifier used to conceal the subscriber's permanent identity (SUPI) in 5G networks.

In step 540, the processor 370 utilizes the collected identifying information to find a corresponding mobile station international subscriber directory number (MSISDN) regardless of the identification information collected in step 530. The MSISDN is more commonly known as the phone number of the wireless device. When sending a text message or making a call, the number utilized is the MSISDN. In embodiments provided herein, the processor 370 may access a database that correlates the provided identifier with the MSISDN. Network operators typically maintain such a database for their own customers, which may in embodiments provided herein, be shared for a limited purpose such as enhancing coverage. Further, mobile number portability (MNP) databases, which store information about ported numbers, may correlate the IMSI numbers with the MSISDN. As a further alternative, some online platforms may offer mobile number lookup services, which can help identify the mobile number associated with an IMSI number. These services may require network operators to provide an IMSI number into a search interface in order to receive the MSISDN.

Using the MSISDN, the processor 370 can trigger push notifications to the wireless devices 140 in step 550. The push notifications may be SMS text messages. The SMS text messages may include information about available coverage. Additionally, the push notification may include a hyperlink allowing a non-subscribing recipient to subscribe to the cellular network. Accordingly, wireless users who frequently enter the selected areas where coverage is unavailable to them will have coverage readily available via hyperlink.

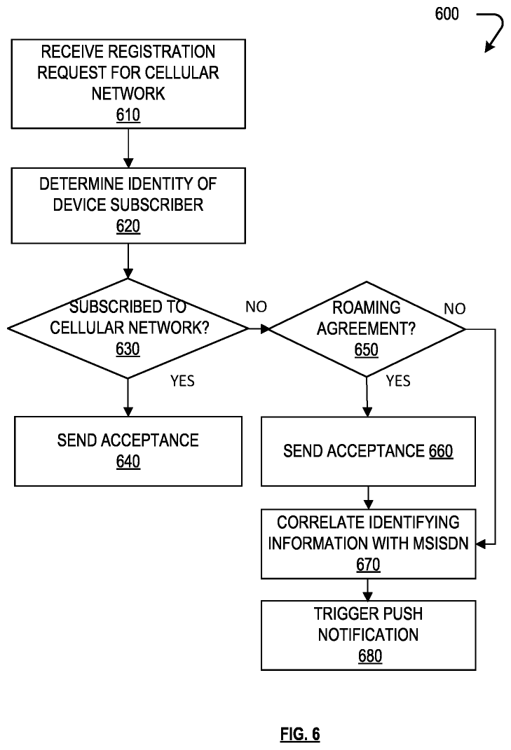

FIG. 6 illustrates a further method 600 for coverage opportunity enhancement in accordance with embodiments set forth herein. In particular, the method 600 illustrates a method for providing coverage enhancement based on a received registration request. Method 600 may be performed by a processor, for example, the processor 370 in the coverage opportunity enhancement system 300 or the processor 370 in combination with other processors of the core network 102. For example, the MME or AMF of the core network 102 may perform steps illustrated herein.

Method 600 starts in step 610, when the core network 102 receives a registration request from a wireless device for the cellular network. The registration request may be received, for example, at an MME or an AMF of the core network 102 depending upon the RAT utilized in the core network 102. As set forth above, the registration request may include information such as the IMSI or SUCI that enables determination of the identity of the wireless device subscriber in step 620. In step 630, the core network 102 determines if the wireless device is subscribed to the cellular network. If the wireless device is subscribed to the cellular network in step 630, the core network 102 may trigger an acceptance in step 640.

However, if the wireless device is not subscribed to the cellular network in step 630, the core network may determine in step 660 if the wireless device subscriber is subscribed to a network having a roaming agreement with the cellular network in step 650. If the roaming agreement exists, the core network 102 will generate an acceptance of the registration request in step 660. However, given that the network to which the wireless device subscribes does not have coverage in the area from which the wireless device generates the request, the processor 370 correlates the identifying information of the wireless device with the MSISDN in step 670 and generates a push notification in step 680. These steps occur substantially as described above with respect to FIG. 5.

Further, if no roaming agreement exists at 650, then the wireless device 140 is unable to obtain coverage at all in the current area and the registration request is denied. Accordingly, in step 670, the processor 370 correlates the identifying information transmitted by the wireless device 140 with a corresponding MSISDN. Finally, in step 680, the processor 370 triggers a push notification to inform the wireless device 140 of available coverage. In embodiments provided herein, the push notification includes a hyperlink allowing the wireless device 140 to subscribe and obtain coverage in the current area.

Accordingly, methods provided herein ensure that wireless devices are able to obtain coverage in areas where coverage is not available from their current network, but is available from other networks. Accordingly, the user experience is considerably enhanced by eliminated coverage gaps.

In some embodiments, methods 400, 500, and 600 may include additional steps or operations. Furthermore, the methods may include steps shown in each of the other methods. As one of ordinary skill in the art would understand, the methods 400, 500, and 600 may be integrated in any useful manner.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication network 100 may be, comprise, or include computers systems and/or processing nodes, including access nodes, controller nodes, and gateway nodes described herein.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
identifying a wireless device within a selected network coverage area for a cellular network based on information contained in a registration request from the wireless device;
accessing a database to correlate the information contained in the registration request with a mobile station international subscriber director number (MSISDN); and
sending a push notification to the MSISDN of the wireless device, the push notification indicating coverage availability of the cellular network in the selected network coverage area.

2. The method of claim 1, where the information contained in the registration request is an international mobile subscriber identity (IMSI) of the wireless device.

3. The method of claim 1, further comprising identifying the selected network coverage area from a heat map created based received registration requests.

4. The method of claim 1, further comprising identifying multiple wireless devices in the selected network coverage area and sending the push notification to the multiple wireless devices.

5. The method of claim 1, further comprising receiving the registration request from customers of another cellular network.

6. The method of claim 5, further comprising denying the registration request and sending the push notification upon denial of the registration request.

7. The method of claim 5, further comprising accepting the registration request and sending the push notification upon acceptance of the registration request.

8. The method of claim 1, further comprising identifying a wireless device subscriber for the wireless device as a subscriber to another cellular network.

9. The method of claim 8, further comprising including a hyperlink for the wireless device to obtain service from the cellular network.

10. The method of claim 9, wherein the push notification identifies the cellular network.

11. A system comprising:
communication circuitry receiving registration requests from wireless devices within a selected network coverage area of a cellular network;
a memory storing instructions and data; and
a processor accessing the stored instructions and performing operations including;
identifying wireless device information within the registration requests;
correlating the wireless device information with a mobile station international subscriber director number (MSISDN); and
sending a push notification to the MSISDN of the wireless device, the push notification indicating coverage availability of the cellular network in the selected network coverage area.

12. The system of claim 11, wherein the wireless device information comprises an international mobile subscriber identity (IMSI).

13. The system of claim 11, the operations further comprising creating a heat map based on the received registration requests and using the heat map to identify the selected network coverage area.

14. The system of 11, the communication circuitry receiving the registration requests from customers of another cellular network.

15. The system of claim 11, the operations further comprising denying the registration request and sending the push notification upon denial of the registration request.

16. The system of claim 11, the operations further comprising identifying a wireless device subscriber for the wireless device as a subscriber to another cellular network.

17. The system of claim 11, the push notification including a hyperlink for the wireless device to obtain service from the cellular network.

18. A non-transitory computer-readable medium storing instructions executed by a processor to perform operations comprising:
identifying a wireless device within a selected network coverage area for a cellular network based on an international mobile subscriber identity (IMSI) of the wireless device received with a roaming request;
accessing a database to correlate the IMSI with a mobile station international subscriber director number (MSISDN); and
triggering a push notification to the MSISDN of the wireless device, the push notification indicating coverage availability of the cellular network in the selected network coverage area.

19. The non-transitory computer readable medium of claim 18, the operations further comprising identifying a wireless device subscriber for the wireless device as a customer of another cellular network.

20. The non-transitory computer readable medium of claim 19, the push notification including a hyperlink for the wireless device to obtain service from the cellular network.
